(19) United States
(12) Patent Application Publication
(10) Pub. No.: US 2018/0126340 A1
(43) Pub. Date: May 10, 2018

(54) AGITATOR DEVICE

(71) Applicant: EKATO Rühr- und Mischtechnik GmbH, Schopfheim (DE)

(72) Inventor: Jochen JUNG, Loerrach (DE)

(21) Appl. No.: 15/572,198

(22) PCT Filed: May 18, 2016
(86) PCT No.: PCT/EP2016/061096

§ 371 Date: Nov. 7, 2017

(30) Foreign Application Priority Data
May 26, 2015 (DE) 10 2015 108 260.8

(51) Int. Cl. B01F 3/04; B01F 5/04; B01F 7/00; B01F 15/00

(52) U.S. Cl. CPC B01F 3/04539; B01F 5/0451; B01F 7/00158; B01F 7/00275; B01F 7/00691; B01F 7/007; B01F 2015/00649; B01F 15/00136; B01F 15/00155; B01F 15/00162; B01F 2003/04546; B01F 2003/04567; B01F 15/00032

(57) ABSTRACT

The invention relates to an agitator device having a static unit and a rotational unit which is in the form of an agitator shaft and, in an assembled state, forms together with the static unit at least one common fluid channel for a fluid. It is proposed that a flow cross-section of the fluid channel, viewed along a main course of flow, is at least substantially constant at least in a coupling region between the static unit and the rotational unit.

### STATE OF THE ART

The present invention refers to an agitator device according to the preamble of claim 1.

U.S. Pat. No. 6,860,474 B2 discloses an agitator having a static unit as a gas supply unit, and a rotational unit, adapted as an agitator shaft, which together with the static unit form a common fluid channel for a gas. In order to introduce a gas into the rotational unit, the rotational unit is provided in a coupling region between the static unit and the rotational unit with a plurality of passage openings, which strongly reduce a flow cross section of the fluid channel along a main course of the flow.

The object of the inventions is in particular to provide an agitator device with improved properties regarding the efficiency. This object is achieved by the characteristics of claim 1, while advantageous embodiments and developments of the invention may be obtained in the dependent claims.

### Advantages of the Invention

The invention is based on an agitator device with a static unit and with a rotational unit, which is formed as an agitator shaft, and which, in an assembled state, forms together with the static unit at least one common fluid channel for a fluid, in particular a liquid and/or advantageously a gas, in particular for introducing the fluid into a container and/or an agitator medium.

It is proposed that a flow cross-section of the fluid channel, viewed along a main course of flow, is at least substantially constant in a coupling region between the static unit and the rotational unit. The flow course of the fluid channel, in particular the main flow course, is essentially free of direction changes at least in the coupling region. In particular the changes of direction are at most equal to 90°, preferably 50° and particularly preferred at most 25°. The flow course of the fluid channel, in particular the main flow course, at least in the coupling region, is in particular completely free from flow deviations. In particular it may be envisaged, that the flow cross-section of the fluid channel along the main flow course, is at least substantially constant over the entire extension and/or the main extension length of the static unit and/or of the rotational unit.

The term “agitator device” refers in particular at least to a portion and/or a construction group, in particular a subgroup, of an agitator. In particular, the agitator device may also comprise the entire agitator. In particular, the agitator differs from a propeller and/or ventilator, in particular for supplying air. Moreover, the agitator device may in particular comprise a drive unit, in particular at least one motor and/or at least one transmission and/or at least an agitator member. The drive unit may in particular be at least partially, advantageously at least mainly and in particular completely positioned between the container and the static unit.

The term “static unit” in this context should in particular mean an unmovable unit, in particular remaining in at least one operating condition and/or advantageously in a mounted state, in particular a supply unit, which comprises, in particular, at least one fluid channel portion of the fluid channel and/or defines the same and which is in particular provided for conducting a fluid, in particular the fluid, at least partially and/or to guide the same. The static unit is advantageously tubular, in particular it has a hollow tubular form. The static unit is also in particular connected, in a mounted state, with at least an inlet for a fluid and in particular for supplying the fluid in particular through the fluid channel portion of the rotational unit. The term “provided” is in particular to be understood as having a special construction and/or equipment. An object being provided with a special function is to be construed in particular as the object fulfilling and/or performing this function in at least one application and/or operating state.

Moreover, a “rotational unit” is to be construed in particular as a unit which in particular with respect to the static unit, is movable, and/or movably supported, in particular by rotating and/or being rotatably supported around an axis of rotation, advantageously a supplying unit, which in particular comprises at least a further fluid channel portion of the fluid channel and/or defines the same and in particular is provided to guide a fluid, in particular the fluid, at least partially. The rotational unit is in particular tubular, in particular a hollow tube. The rotational unit is provided to supply the fluid, in particular the fluid delivered by the static unit to the agitation medium, in particular by means of at least a fluid outlet opening. The rotational unit is an agitator shaft, in particular a hollow agitator shaft, and is in particular adapted for house and/or support an agitator member hub of the at least one agitator member. Moreover, the rotational unit advantageously has at least one active connection to the drive unit. Moreover, the rotational unit is preferably disposed in a completely assembled state at least partially and preferably at least mostly in the container. The term “at least mostly” means in particular at least 50%, preferably at least 70% and in particular at least 90%. The fluid channel portion of the static unit and the further fluid channel portion of the rotational unit define the entire fluid channel at least mostly and in particular entirely.

Moreover, the term “main flow course” in particular means an effective flow course and/or an effective flow direction. Advantageously, the main flow course is at least essentially disposed and/or directed in parallel to a main extension direction of the rotational unit. In this context the term “at least essentially parallel” means in particular a direction relative to a reference direction, in particular in a plane, wherein the direction has a deviation relative to the reference direction in particular less than 8°, advantageously less than 5° and in particular less than 2°. The term “main extension direction” of an object is moreover intended to refer to a direction which is parallel to a longest edge of a minimum parallelepiped, which barely still completely surrounds the object.

Moreover, the term “coupling region” refers in particular to a bonding region and/or connection region, in particular between the static unit and the rotational unit. A coupling region is in particular a near region, in particular between the static unit and the rotational unit. In particular, a coupling region is in particular a region, in which the static unit and the rotational unit overlap and/or are at least enveloping themselves. A “near region” is in this context in particular a spatial region, which is formed by points, which have respectively a distance of at most 15%, preferably at most 10% and in particular at most 5% of a maximum extension and/or the main extension length of the rotational unit and/or in particular at most 5 m, preferably at most 1 m and in particular preferably at most 0.5 m from a reference point and/or a reference component.

An “at least substantially constant flow cross section” of an object is also in particular a flow cross section, which deviates from a flow cross section averaged over the object by at most 20%, advantageously at most 10%, preferably at most 5% and in particular at most 2%. Due to this configuration, an agitator device with improved properties regarding efficiency, in particular power efficiency, spatial occupation efficiency, component efficiency and/or cost effectiveness may be provided. Moreover an advantageous feeding behavior of the fluid may be achieved, wherein pressure drops and/or pressure losses may be advantageously reduced. Moreover, in particular, a uniform power transmission to the agitation medium may be achieved, wherein volumetric flows up to 15000 Nm³/h may be achieved. Moreover, advantageously, a constructively simple and/or robust agitator device may be provided. Moreover, due to the optimized geometry, a durability and/or operating life of the agitator may be increased, occlusions may be minimized and costs may be advantageously reduced. Moreover, in particular, in case of positioning the static unit above the rotational unit and/or laterally with respect to the rotational unit, an improved accessibility may be provided, whereby in particular interruption-free servicing maybe ensured. Moreover in particular, when positioning the drive unit between the container and the static unit, a mechanical load on the static unit, in particular in case of deviations of the rotational unit, may be reduced and/or avoided, since deviations in particular due to the drive unit may be absorbed.

The flow cross section in the coupling region preferably has a surface area of at least 15%, advantageously at least 25%, preferably at least 35% and in particular of at least 50% of a maximum flow cross section of the fluid channel and advantageously at least of the further fluid channel portion of the rotational unit. In particular, the flow diameter of the fluid channel at least in the coupling region is between 25 mm and 500 mm and advantageously between 50 mm and 300 mm. In this way, pressure drops and/or pressure losses may in particular be advantageously kept at low level.

If the fluid channel in the coupling region along the main flow course has a curve radius, which is at least equal to an inner diameter of the static unit, preferably at least 1.5 times the inner diameter of the static unit and in particular preferably at least 3 times the inner diameter of the static unit, an advantageous uniform flow behavior may be achieved. In particular, the flow channel may also be straight at least in the coupling region along the main flow course.

The static unit may surround the rotational unit in the coupling region at least partially, preferably at least mostly and in particular completely. The rotational unit, however, surrounds the static unit in the coupling region at least partially, preferably at least mostly and in particular completely. In this way, in particular an advantageous sealing, in particular between the static unit and the rotational unit, may be achieved.

It is also proposed, that the agitator device has a rotational passage, which comprises, in particular at least a part of the rotational unit positioned in the coupling region, at least a part, in particular at least a part positioned in the coupling region of the static unit and a bearing unit, in particular with at least one journal bearing and advantageously with at least one roller bearing. The rotational passage is advantageously provided for connecting the in particular movable rotational unit to the static unit. The rotational passage preferably comprises in particular additionally a sealing unit, with at least one sealing element formed by a stuffing box. In this way, in particular, a constructively simple transition to the movable rotational unit may be provided.

In a particularly preferred embodiment of the invention it is proposed that the static unit and/or the rotational unit has at least one separation unit, which is advantageously at least pressure tight and/or fluid tight, preferably gas tight, which is provided for allowing a separation of the static unit and/or rotational unit. In particular, the separation unit may be positioned on a side of the coupling region facing the static unit and in particular in order to separate the static unit, in particular a part of the static unit from a further part of the static unit. In particular, the separation unit may be positioned on the side of the coupling region facing the rotational unit and in particular in order to separate the rotational unit, in particular a part of the rotational unit from a further part of the rotational unit. Moreover it may be envisaged that the separation unit is at least essentially positioned in a central position in the coupling region and/or between the static unit and the rotational unit and in particular in order to separate the static and the rotational unit from each other. In this way, in particular, the accessibility may be improved, whereby the servicing is advantageously simplified.

The separation unit may be provided as any separation unit which appears reasonable to the skilled in the art, such as for example a screwed coupling, in particular a flange coupling. The separation unit may however be a quick plugin coupling. In this way, a particularly time efficient and thus in particular cost effective servicing may be achieved.

It is also proposed that the agitator device has at least one encasing unit, provided as an advantageous protective unit, which surrounds and/or encompasses the rotational unit in at least one operating condition at least mostly and advantageously completely, in particular in a way that the rotational unit in the operating condition is closed in the direction of a peripheral region, in particular surrounding the rotational unit and/or the static unit, and which in particular is inaccessible from the outside. In particular, the encasing unit may be provided as a separate and/or additional component. Advantageously, the encasing unit is however a part of the static unit and in particular at least partially integral with the static unit. The term “at least partially integral” in this context in particular means that at least one component of the at least one object and/or the at least one object is integral with at least one component of the at least one other object and/or the at least one other object. “Integral” means in particular an at least material connection. The material connection may be provided for example by the process of gluing, welding, soldering and/or another process, which may be considered reasonable by the skilled in the art. The term integral advantageously refers to formed in one piece and/or made of one piece. Preferably, this one piece is provided from a single blank, a mass and/or a cast, such as in an extrusion process, in particular a one and/or multiple component extrusion process, and/or an injection molding process, in particular a one and/or multicomponent injection molding method. In this way, in particular, an advantageous protective effect may be achieved. In particular it may be avoided, that dirt and/or deposits collect in a transition region between the static and the rotational unit. Moreover, advantageously, the operating safety may be improved, wherein in particular it may be prevented that the rotating parts are positioned in the accessible area of a user. Moreover the operating life and/or durability may be improved.

In an embodiment of the invention it is proposed that the agitator device has at least one lance element, in particular a flushing lance and/or a dosing lance, which, in at least one operating condition is at least partially and preferably at least mostly positioned inside the fluid channel. In a particularly preferred embodiment, the lance element may also be permanently, at least partially and preferably at least mostly positioned inside the fluid channel. In particular, the fluid channel has at least one lance housing region, in which the lance element is positioned in at least one operating condition and advantageously permanently. A “flushing lance” is in particular meant to be in particular a lance element which is at least partially flexible and/or disassemblable, which in particular is provided for emit and/or eject in at least one operating condition a flushing fluid, in particular at high pressure, in particular a high pressure fluid, in order in particular to remove possible deposits, in particular occlusions and/or blocks, in particular in the fluid channel and/or for flushing clean the at least one fluid outlet opening. Moreover, a “dosing lance” is in particular a lance element, which is at least partially flexible and/or disassemblable, which is particularly provided for dosing and in particular delivering in a controlled way to the agitation medium in at least one operating condition a dosing fluid, advantageously a liquid. In this way, the service life, the durability and/or the mixing behavior may be improved. Moreover, advantageously, the result of the process may be improved in connection with a gassing task, which is running in particular in parallel and/or simultaneously, such as in case of addition of sulfur acid and gassing with air and/or pure oxygen and/or addition of a cyanide-containing solution and gassing with air and/or pure oxygen. Moreover a starting up in a sediment, in particular when the agitator member is stuck, may be facilitated and in particular simplified, in particular in a constructive way, with respect to conventional solutions.

Moreover it is proposed that the agitator device has at least one pressure measuring unit, preferably a Prandtl probe, which is at least partially, preferably at least mostly and in particular completely positioned inside the fluid channel. In particular, the fluid channel has at least one pressure measuring unit housing region, in which the pressure measuring unit is disposed. In this way, the pressure, in particular the hydrostatic pressure, in particular required for introducing the fluid into the container and/or the agitation medium, may be easily determined.

If the agitator device has at least one flowmeter unit, preferably a flow probe, a thermal flow sensor, an anemometer, and/or a Coriolis flowmeter, which are at least partially preferably at least mostly and in particular completely disposed inside the fluid channel, a volumetric flow may in particular be detected, whereby in particular in connection with the measurement of an in particular static pressure, possible occlusions may be detected. In particular, the fluid channel has at least one flowmeter unit housing region, in which the flowmeter unit is positioned.

It is also proposed that the agitator device has at least one filling level measurement unit, which is preferably partially, preferably at least mostly and in particular completely positioned inside the fluid channel, and which is in particular provided for detecting, in at least one operating condition, a filling level and/or a filling height of fluid, in particular of the fluid inside the rotational unit. The measurement of the filling level and/or height may be performed by any measurement method considered suitable by the skilled in the art, such as by mechanical measurement, pressure measurement, conductivity measurement, capacitive measurement and/or advantageously by optical, in particular contactless measurement. The filling level measurement unit may preferably be comprised of a preferably guided radar sensor, and/or a particularly guided ultrasound sensor. The filling level measurement unit may advantageously be provided with a lance element, in particular above mentioned lance element, at least partially integrally formed. In particular the measurement unit is integrated at least partially, preferably at least mostly and in particular completely in the lance element. In this way a particularly efficient and/or space neutral detection of the filling level may be accomplished.

In a preferred embodiment of the invention it is proposed that the lance element, the pressure measurement unit, the flowmeter unit and/or the filling level unit is/are at least partially positioned in the coupling region, whereby in particular a constructively simple configuration as well as an advantageous servicing may be obtained.

A particularly high flexibility may be obtained in particular when the rotational unit is formed at least in portions and advantageously over the entire extension and/or the main extension as a multiple shaft. In this context, a “multiple shaft” is in particular a rotational unit, which comprises at least two advantageously concentrically positioned, mutually sealed hollow shafts, which are provided in particular for guiding and/or conducting at least partially in at least one operational condition and in particular simultaneously a fluid, preferably multiple fluids.

If the agitator device has at least one ribbed unit, which is at least partially, preferably mostly and in particular entirely positioned within the fluid channel and is provided for mechanically stabilizing, at least in portions, the static unit and/or the rotational unit and/or to at least partially guide the fluid, an in particular robust agitator device may be provided and/or a flow behavior of the fluid may advantageously be influenced. The ribbed unit is preferably a reinforcing unit and in particular positioned in a region of the transmission of the drive unit, whereby in particular a speed of the drive motor of the drive unit is transmitted to the rotational unit, and the flow cross section of the fluid channel may be advantageously maximized. It is particularly preferred that the ribbed unit is at least partially integral with the rotational unit.

Moreover, a system, in particular an agitator system, in particular an ore processing system with at least one, in particular horizontally and/or advantageously vertically positioned container, in particular a pressure container, in particular for housing an agitation medium, and with at least one agitator disposed in the container with at least one agitator device is proposed. A part of the agitator, in particular the rotational unit, may be inserted in any way that appear suitable to the skilled in the art, advantageously centrally, in particular from above, from beneath and/or laterally in the container. Alternatively it may however also be envisaged that the part of the agitator, in particular the rotational unit, is introduced in the container with a lateral offset and thus in particular in an edge region of the container. In particular, the system may also comprise a plurality of agitators. The agitator system may also comprise in particular at least one agitation medium positioned in the container. Due to this configuration of the system an optimized and durable agitator system may be provided, in particular with respect to a power efficiency, a space efficiency, a component efficiency and/or a cost effectiveness, wherein the supply behavior and/or the introduction of fluid in the agitation medium may be influenced and/or controlled in a targeted way.

The agitator device should not be limited to the above application and embodiment. In particular, the agitator device may be provided with a number of individual elements, components and units, differing from the cited number in order to achieve the described function.

### DRAWINGS

Further advantages are obtained from the following description of the drawings. In the drawings two exemplary embodiments of the invention are illustrated. The drawings, the description and claims contain various characteristics in combination. The skilled in the art may advantageously consider the characteristics also individually and combine the same into further combinations.

In particular:

FIG. 1 shows a system with a container and an agitator with an agitator device in a lateral sectional view,

FIG. 2 shows the agitator device in an enlarged partial representation,

FIG. 3 shows a further system with a container and an agitator with a further agitator device in a lateral sectional view,

FIG. 4 shows the agitator device of FIG. 3 in an enlarged partial representation,

FIG. 5 shows a further system with a container and an agitator with a further agitator device in a lateral sectional view,

FIG. 6 shows a further system with a container and an agitator with a further agitator device in a lateral sectional view, and

FIG. 7 shows a further system with a container and an agitator with a further agitator device in a lateral sectional view.

### DESCRIPTION OF THE EXEMPLARY EMBODIMENTS

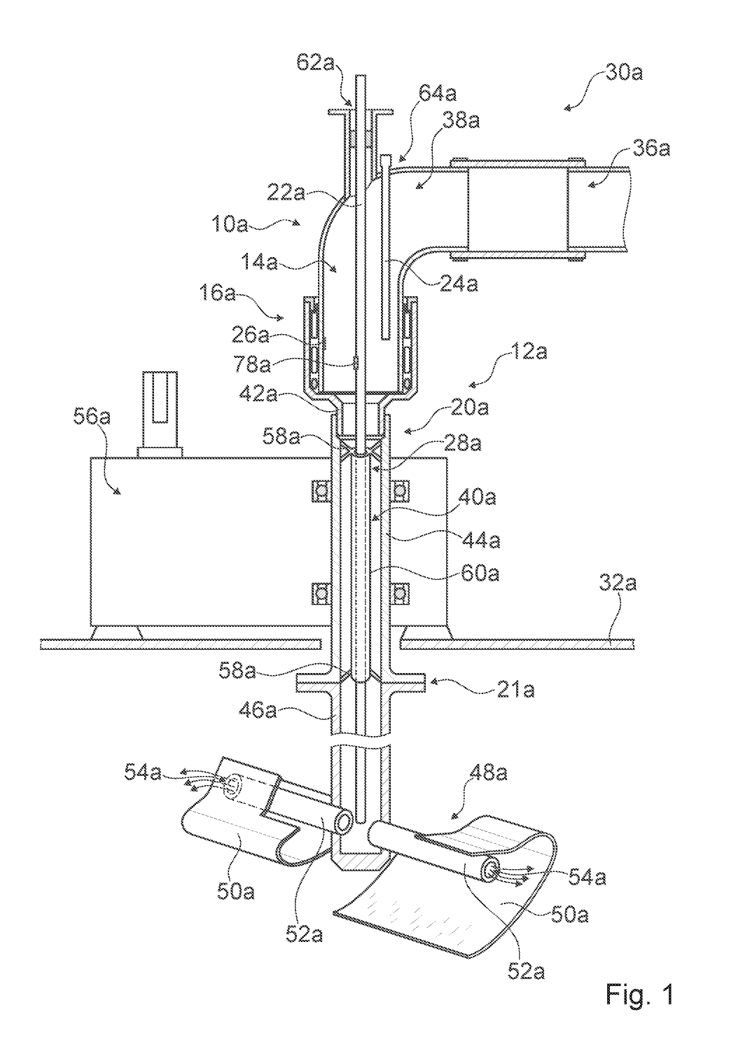

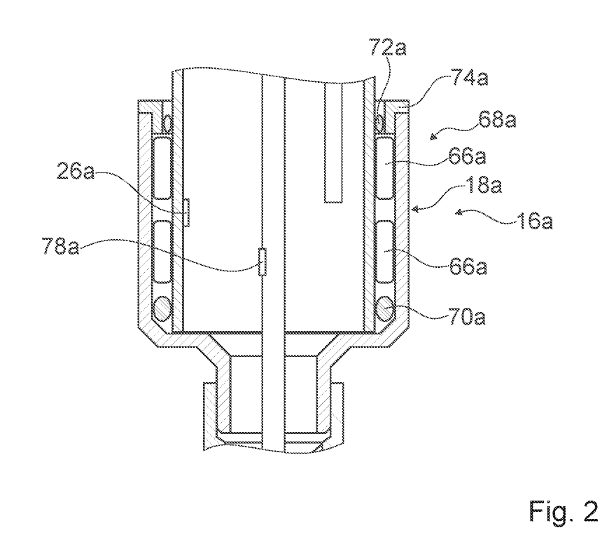

FIGS. 1 and 2 show a first exemplary embodiment of an example of an ore processing system in a fully assembled state in a schematic sectional view. The system comprises a vertically positioned container 32a, which in particular is only partially shown in FIG. 1. The container 32a has a volume between 100 and 1000 m³. In the present case, the container has a volume of 500 m³. The system also comprises an agitation medium disposed in the container 32a (not shown in FIG. 1). The system also comprises an agitator 30a. The agitator 30a is adapted for agitating the agitation medium contained within the container 32a. The agitator 30a is also adapted in this case for gassing the agitation medium contained in the container 32a. The agitator 30a is adapted for introducing at least one fluid into the agitation medium. Alternatively it is envisaged to provide a fermenting system. It is also envisaged that the agitator is provided for mixing, homogenizing, dispersing and/or suspending an agitation medium.

The agitator 30a comprises an agitator device. The agitator device comprises a supply line 36a. The supply line 36a is provided for supplying at least one fluid. In the present case, the supply line 36a is a gas supply line and in particular provided for supplying air. The supply line 36a is horizontal, in particular with respect to the container 32a. Alternatively a supply line may be provided, which supplies a gas different from air and/or a liquid, such as pure oxygen. Moreover, a supply line may be positioned at least substantially in a vertical position with respect to container.

The agitator device comprises a static unit 10a. The static unit 10a is positioned completely outside the container 32a. The static unit 10a is immovable with respect to container 32a. Herein, the static unit 10a is integrally formed. The static unit 10a may be made at least partially, preferably at least mostly and most preferably entirely of any base material that appear suitable to the skilled in the art, such as plastics, ceramics, an alloy and/or metal, in particular an unalloyed steel, duplex steel, stainless steel, titan and/or zircon. Herein the static unit 10a is made of stainless steel. The static unit 10a is a hollow tube. The static unit 10a is a supply unit. The static unit 10a has an inner cladding which is made of a material differing from the base material of the static unit 10a, in this case a coating. The inner cladding is made of ceramics and/or plastics and prevents in particular the fixing of fluid. Moreover, the inner cladding improves the friction characteristics of the static unit 10a. Alternatively, an inner cladding may also be made of a different material, suitable for the skilled in the art, in particular depending on the base material used. Moreover it may be envisaged that an inner cladding of a static unit may be formed, alternatively or additionally, by an element, in particular an additional element, in particular a pipe and/or a sleeve. It is also envisaged to entirely omit the inner cladding.

The static unit 10a has a first fluid channel portion 38a. A flow cross section of the first fluid channel portion 38a is at least substantially constant along a main flow course. Moreover, the static unit 10a is connected to the supply line 36a. Herein, the static unit 10a is indirectly connected, in particular through a flexible connection, to the supply line 36a, whereby in particular possible oscillations and/or tolerances in the production of the connection and/or during the operation may be compensated. The static unit 10a is also curved. The static unit 10a has a bending. The static unit 10a has an angle of curvature of about 90°. The static unit 10a has a radius of curvature which is at least essentially equal to the inner diameter of the first fluid channel portion 38a. Moreover the static unit 10a has two housing openings 62a, 64a. The housing openings 62a, 64a are positioned in a near region of the bending of the static unit 10a.

The housing openings 62a, 64a are sealed with respect to the environment in a way that appear suitable to the skilled in the art. Alternatively it is possible to omit at least one of the housing openings and/or all housing openings. It may also be possible to provide further housing openings for further functional elements. A static unit may also be essentially straight and/or made of a plurality of parts.

The agitator device also comprises a rotational unit 12a. The rotational unit 12a may be made at least partially, preferably mostly and in particular entirely of any base material that appear suitable to the skilled in the art, such as plastics, ceramics, an alloy and/or metal, in particular an unalloyed steel, duplex steel, stainless steel, titan and/or zircon. At least a region, which is in contact with the agitation medium, may be advantageously made of a rubber coating, titan and/or zircon. Herein, the rotational unit 12a is made of stainless steel. The rotational unit 12a is at least mostly positioned inside the container 32a. The main extension length of the rotational unit 12a is vertical, in particular relative to the container 32a, and/or perpendicular to the supply line 36a. The rotational unit 12a is inserted centrally from above into the container 32a. The rotational unit 12a is movable. The rotational unit 12a is provided for rotation at least in operation about an axis of rotation. The rotational unit 12a is a hollow tube. In the present case the rotational unit 12a is made of an agitator hollow shaft. The rotational unit 12a is a simple shaft. The rotational unit 12a is also a supply unit. The rotational unit 12a has a further inner cladding, in the present case a coating. The further inner cladding is made of ceramics, plastics and/or a rubber coating and prevents in particular a fixing of the fluid and/or the flushing of penetrated agitation medium after an unplanned stop of the plant. Moreover, the additional inner cladding improves the friction characteristics of the rotational unit 12a. Alternatively an additional inner cladding may also be made of a different material that appears suitable to the skilled in the art, depending on the base material in use. It is also envisaged that an additional inner cladding of a rotational unit is formed, alternatively or additionally, of an in particular additional element, in particular a pipe and/or sleeve. The additional inner cladding may also be completely omitted.

The rotational unit 12a has a second fluid channel portion 40a. The flow cross section of the second fluid channel portion 40a is at least in portions at least substantially constant along the main flow course. The rotational unit 12a is connected to the static unit 10a. A connection region of the rotational unit 12a with the static unit 10a defines a coupling region between the static unit 10a and the rotational unit 12a. Herein, the rotational unit 12a surrounds the static unit 10a in the coupling region entirely. A detailed description of a connection between static unit 10a and rotational unit 12a is provided with reference to FIG. 2. The rotational unit 12a forms together with the static unit 10a a common fluid channel 14a. Herein, the first fluid channel portion 38a and the second fluid channel portion 40a define the fluid channel 14a. The flow cross section of the fluid channel 14a is at least substantially constant at least in the coupling region between the static unit 10a and the rotational unit 12a, as viewed in the main flow course. Herein, the flow cross section in the coupling region has a surface area of at least 70% of a maximum flow section of the fluid channel 14a. The fluid channel 14a in the coupling region, as viewed in the main flow direction, has a radius of curvature, which is at least equal to the inner diameter of the static unit 10a. The fluid channel 14a is provided for introduce the fluid of the supply line 36a into the container 32a and/or in the agitation medium. Alternatively a rotational unit may be introduced into the container from beneath and/or from a side. A rotational unit may also be laterally offset with respect to a central point of the container and thus be in particular introduced in an edge region of container into the container. Moreover, a rotational unit may be a multiple shaft, so that the rotational unit in at least one operational state may supply and/or conduct in particular simultaneously at least two different fluids.

The rotational unit 12a is also provided in multiple parts. Herein, the rotational unit 12a is at least in three parts. A first part 42a of the rotational unit 12a is a coupling shaft. The first part 42a of the rotational unit 12a is entirely positioned outside the container 32a. The first part 42a of the rotational unit 12a is provided for coupling with the static unit 10a. A second part 44a of the rotational unit 12a is a drive shaft. The second part 44a of rotational unit 12a is at least mostly positioned outside the container 32a, herein in particular above an upper container edge. The second part 44a of the rotational unit 12a is for driving the rotational unit 12a. A third part 46a of the rotational unit 12a is an agitator shaft. The third part 46a of the rotational unit 12a is entirely positioned within the container 32a. The third part 46a of the rotational unit 12a is provided for supporting at least one agitator member 48a. The rotational unit 12a is also separable. In order to separate the rotational unit 12a, the rotational unit 12a has two separation units 20a, 21a. The separation units 20a, 21a are fluid tight and/or pressure tight, in particular up to a pressure of at least 10 bar. A first separation unit 20a is a quick plugin coupling. The first separation unit 20a is positioned outside the container 32a. The first separation unit 20a is also positioned in a nearby region of the static unit 10a. The first separation unit 20a is provided for separating the first part 42a of the rotational unit 12a from the second part 44a of the rotational unit 12a. A second separation unit 21a is a flange coupling. The second separation unit 21a is positioned within the container 32a. The second separation unit 21a is provided for separating the second part 44a of the rotational unit 12a from the third part 46a of the rotational unit 12a. Alternatively, a rotational unit may be formed integrally and/or in one piece. It is also envisaged to provide a first separation unit and/or a second separation unit as a different separation unit, that appears to be suitable to the skilled in the art.

In order to agitate the agitation medium, the agitator device also has the at least one agitator member 48a. The agitator member 48a is a type of agitator member, which is particularly suitable for gassing operations. The agitator member 48a is made of stainless steel. The agitator member 48a is attached to the rotational unit 12a, in particular to the third part 46a of the rotational unit 12a. The agitator member 48a also comprises a plurality of agitator blades 50a. In this case, the agitator member 48a comprises at least two agitator blades 50a. Alternatively, the agitator member may also have at least three, at least four and/or any other number of agitator blades. The agitator blades 50a are at least substantially identical to each other. The agitator blades 50a are integrally formed. The agitator blades 50a are also indirectly attached to the rotational unit 12a. To this end, the agitator member 48a comprises a plurality of support arms 52a. Each support arm 52a is associated to one of the agitator blades 50a. The support arms 52a are provided each as a rod-like spar. The support arms 52a are hollow tubes. The support arms 52a have respective additional fluid channel portions. The additional fluid channel portions of support arms 52a are fluidically connected to the fluid channel 14a, in particular the second fluid channel portion 40a of the rotational unit 12a. The support arms 52a also have, on a side opposed to the rotational unit 12a at least a respective fluid outlet opening 54a. The fluid outlet openings 54a are provided for introduce the fluid supplied in the fluid channel 14a into the container 32a and/or agitator medium. The fluid outlet openings 54a are also provided here with check valves (not shown), which are in particular provided for automatic mechanical closing in case of a pressure drop in the fluid channel 14a and/or in the supply line 36a and thus in particular avoid penetration of the agitation medium. Alternatively check valves may be omitted. For introducing a fluid into a rotational unit additional fluid inlet elements different from the support arms, advantageously rotating with the rotational unit may be provided, wherein the fluid inlet elements may be positioned in particular in any region of the rotational unit. A fluid may also be introduced through a plurality, in particular vertically positioned and distributed levels, wherein the dosing may be set by means of different flow cross sections of fluid outlet opening at the different levels. An agitator device may also have a plurality of agitator members, in particular at least two and/or at least three agitator members. At least one of the agitator members may be preferably composed, at least mostly and in particular entirely of a ceramic, an alloy and/or a metal, in particular an unalloyed steel, advantageously provided with a rubber coating, duplex steel, titan and/or zircon. It is also possible that the agitator blades have another form and/or profile that appears to be suitable to the skilled in the art, and or may be directly attached to a rotational unit.

The agitator device comprises, for driving the rotational unit 12a, also at least one drive unit 56a. The drive unit 56a is entirely positioned outside the container 32a. The drive unit 56a is here positioned above the container 32a. The drive unit 56a is also positioned underneath the static unit 10a. The drive unit 56a is positioned on a side of the rotational unit 12a. The drive unit 56a comprises a drive motor, a transmission, in particular a hollow shaft transmission, as well as a drive support unit for the rotational unit 12a. In the present case, the drive unit 56a surrounds the rotational unit 12a at least partially. The drive support unit surrounds the second part 44a of the rotational unit 12a at least partially. The drive unit 56a is provided for transmitting a torque to the rotational unit 12a. Here, the drive unit 56a is provided for transmitting a torque to the second part 44a of the rotational unit 12a, in particular in order to provide rotation of the rotational unit 12a. In order to reinforce and/or stiffen the rotational unit 12a, the agitator device also comprises a ribbed unit 28a. The ribbed unit 28a is positioned in the fluid channel 14a. Here, the ribbed unit 28a is in the second fluid channel portion 40a and in particular in a region of the second part 44a of the rotational unit 12a. The ribbed unit 28a is integrally formed. The ribbed unit 28a is also integral with the rotational unit 12a, in particular with the second part 44a of the rotational unit 12a. The ribbed unit 28a is provided for mechanically stabilize the rotational unit 12a, in particular the second part 44a of the rotational unit 12a. To this end, the ribbed unit 28a has a plurality of ribs 58a, which in an assembled state are supported by an inner wall of the fluid channel 14a. Thereby the speed of the drive motor may be advantageously transmitted to the rotational unit 12a. At the same time, the flow cross section of the fluid channel 14a may be advantageously held at least substantially constant. The ribbed unit 28a also comprises at least one lance guiding element 60a. The lance guiding element 60a has a hollow tubular form. The lance guiding element 60a is centrally positioned within the fluid channel 14a. The lance guiding element 60a extends at least substantially over the entire main extension length of the second part 44a of the rotational unit 12a. The lance guiding element 60a is provided for guiding a lance element 22a in at least one operational state. The ribbed unit 28a is also adapted for advantageously influencing the fluid-dynamic behavior of the fluid. Alternatively, a drive unit may be positioned laterally and/or beneath a container and/or at least partially in the container. It is also possible to entirely omit the ribbed unit and/or to provide a ribbed unit in multiple parts and/or to position the ribbed unit in another region of the fluid channel. A ribbed unit may also correspond to a profile and/or ribbed structure provided in particular on an inner wall of a static unit and/or of the rotational unit.

The agitator device also comprises the lance element 22a. The lance element 22a is positioned, in at least one operational state at least mostly in the fluid channel 14a and at least partially in the coupling region. The lance element 22a is also at least partially disposed in the lance guiding element 60a. The lance element 22a extends, in the operational state at least substantially over the entire main extension length of the static unit 10a and rotational unit 12a. The lance element 22a is provided for being inserted through the first housing opening 62a of the static unit 10a into the fluid channel 14a and/or the lance guiding element 60a, in particular so that the lance element 22a is at least partially positioned in the third part 46a of the rotational unit 12a and in particular in a region of the agitator member 48a. To this end, the lance element 22a is at least partially flexible. The lance element 22a is also disassemblable. Here, the lance element 22a is at least substantially provided in the form of a drill pipe, and is composed of single tubes which are screwed to each other. Here, the lance element 22a is a flushing lance, and is provided in particular for emitting a flushing fluid at high pressure, in particular in order to remove possible occlusions in the fluid channel. Thereby in particular a restart in sediments may be advantageously facilitated. Alternatively a lance element may be permanently integrated in an agitator device, and/or a lance element may be provided as a dosing lance.

The agitator device also comprises a filling measurement unit 78a. The filling level measurement unit 78a is positioned, in at least one operational state, entirely in the fluid channel 14a. The filling level measurement unit 78a is here also positioned in the coupling region. The filling level measurement unit 78a is provided for detect, in at least one operational state, a filling level of fluid in the rotational unit 12a. Here, the filling level measurement unit 78a is a radar sensor and provided for detecting the filling level of fluid through a contactless measurement. The filling level measurement unit 78a is also at least partially integrally formed with the lance element 22a. The filling level measurement unit 78a is integrated in the lance element 22a. Alternatively a filling level measurement unit different from a radar sensor may be used and/or it may be completely omitted. A filling measurement unit may also be positioned in another region, such as a region of an agitator member, and/or it may be at least partially integral with a static unit and/or a rotational unit.

The agitator device also comprises a pressure measurement unit 24a. The pressure measurement unit 24a is at least mostly positioned in the fluid channel 14a and partially in the coupling region. The pressure measurement unit 24a is introduced through the second housing opening 64a of the static unit 10a permanently into the fluid channel 14a. Here, the pressure measurement unit 24a is a Prandtl probe. The pressure measurement unit 24a is also provided for detect a pressure, in particular a static pressure of fluid in the fluid channel 14a, which is in particular required for introducing the fluid into the container 32a and/or the agitation medium. Alternatively a pressure measurement unit different from a Prandtl probe may be used and/or it may be only temporarily introduced in a fluid channel. A pressure measurement unit may also be entirely positioned in the coupling region and at least partially integral with a static unit and/or a rotational unit.

The agitator device also comprises a flowmeter unit 26a. The flowmeter unit 26a is positioned in the fluid channel 14a, in particular in the coupling region. The flowmeter unit 26a is at least partially integral with the static unit 10a. The flowmeter unit 26a is integrated in an internal wall of the static unit 10a. Here, the flowmeter unit 26a is a flow probe. The flowmeter unit 26a is provided for detect a volumetric flow of fluid in the fluid channel 14a. To this end, the dynamic flow pressure may be determined, for example.

In connection with a measurement of a static pressure, the operating point may be advantageously determined and possible deviations such as due for example to occlusions, may be recognized. The dynamic pressure is concomitant with a flow velocity. The local flow velocities of a gaseous fluid may be between 1 m/s and 300 ms, however advantageously between 10 m/s and 60 m/s. Here, the average flow velocity of fluid corresponds to approximately 30 m/s+/−10 m/s (locally different from average value). Alternatively the use of a flowmeter unit different from a flow probe may be envisaged, and/or the introduction of a flowmeter unit only temporarily in a fluid channel. It is also envisaged to integrate a flowmeter unit in another region of a static unit and/or of the rotational unit.

Moreover, from the information of the pressure measurement unit 24a and of the flowmeter unit 26a operating parameters of system may be determined, that may be used in particular to control the check valves and/or to adapt the operation automatically and in particular without user intervention to different fluids.

FIG. 2 shows a connection between the static unit 10a and the rotational unit 12a in an enlarged view. The connection between the rotational unit 12a and the static unit 10a occurs by means of a rotational passage 16a of the agitator device. The rotational passage 16a comprises part of the static unit 10a. Here, the rotational passage 16a comprises at least a part of the static unit 10a disposed in the coupling region. The rotational passage 16a comprises at least a part of the rotational unit 12a in the coupling region. The rotational passage 16a also comprises a bearing unit 18a. The bearing unit 18a is in the coupling region. The bearing unit 18a is positioned in a housing region between the static unit 10a and the rotational unit 12a. Here, the bearing unit 18a is positioned between an outer wall of the static unit 10a and an inner wall of the rotational unit 12a. The bearing unit 18a comprises, in this case, two roller bearings 66a. The roller bearings 66a are identical, besides production tolerances. The roller bearings 66a are composed of needle bearings. The rotational passage also comprises a sealing unit 68a. The sealing unit 68a is disposed in the coupling region. The sealing unit 68a is in the housing region between the static unit 10a and the rotational unit 12a. Here, the sealing unit 68a is positioned between an outer wall of the static unit 10a and an inner wall of the rotational unit 12a. The sealing unit 68a comprises at least two sealing elements 70a, 72a. A first sealing element 70a positioned in particular on a side facing the rotational unit 12a is a packing washer. A second sealing element 72a positioned in particular on a side facing the static unit 10a is a sliding ring sealing. The rotational passage 16a also has a closing element 74a. The closing element 74a is provided for closing and/or sealing together with the sealing unit 68a the housing region between the static unit 10a and the rotational unit 12a, in particular relative to the environment. Alternatively a bearing unit may comprise at least one roller bearing different from a needle bearing and/or exactly one roller bearing and/or at least one sliding bearing. A sealing unit may also have exactly one sealing element or identical sealing elements and/or other sealing elements, that appears to be suitable to the skilled in the art, such as labyrinth seals and/or radial shaft sealing rings.

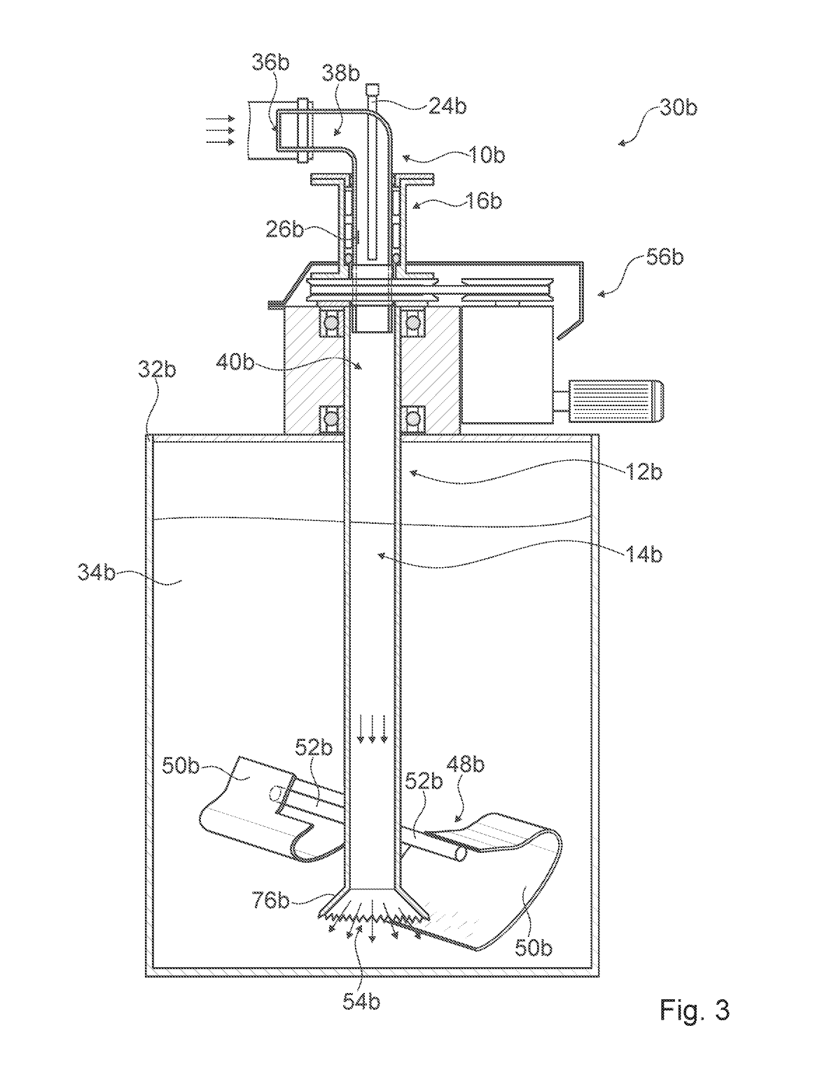

In FIGS. 3 to 7 other exemplary embodiments of the invention are shown, The following description and the drawings are substantially limited to differences between the embodiments, wherein regarding identically references components, in particular components having the same reference numeral, reference may be essentially made also to the drawings and/or description of the other example, in particular to FIGS. 1 and 2. In order to differentiate the examples, the letter a is used as a suffix for references of the example of FIGS. 1 and 2. In the examples of FIGS. 3 to 7, the letter a is replaced by letters b to e.

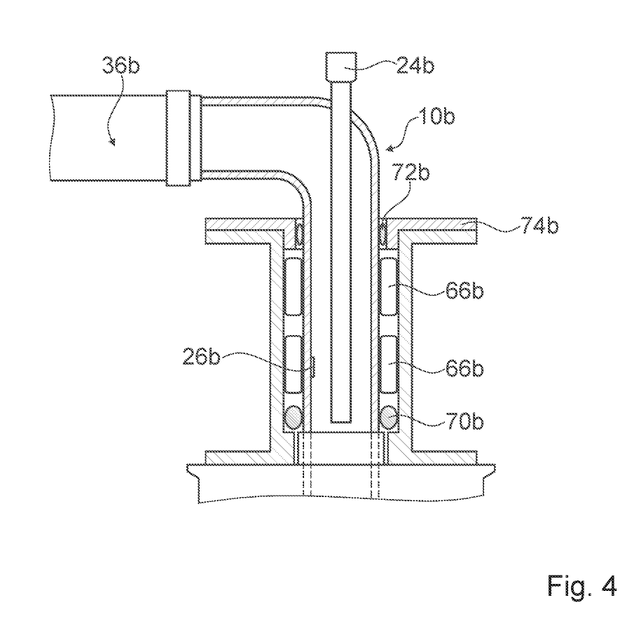

In FIGS. 3 and 4, a further exemplary embodiment of the invention is shown. In example of FIGS. 3 and 4, the suffix b is used. FIGS. 3 and 4 show another system with a container 32b and an agitator 30b with an agitator device in a lateral sectional view (see FIG. 3) and a connection region between a static unit 10b and a rotational unit 12b of the agitator device in an enlarged view (see FIG. 4). An embodiment of systems of FIGS. 3 and 4 is at least substantially identical to an embodiment of the system of FIGS. 1 and 2.

However, in this case, the rotational unit 12b is in one piece. The transmission of torque to the rotational unit 12b also is performed by a belt drive. Moreover, the agitator device comprises here for introducing a fluid in the container 32b and/or into the agitation medium 34b a fluid inlet element 76b. The fluid inlet element 76b is positioned on an end of the rotational unit 12b, that is opposed to the static unit 10b. The fluid inlet element 76b is non-rotatably connected with the rotational unit 12b. The fluid inlet element 76b is at least substantially conical and/or funnel-shaped. The fluid inlet element 76b is here a gas distributor. The fluid inlet element 76b has at least one fluid outlet opening 54b. The fluid inlet element 76b also is separate from support arms 52b of an agitator member 48b. Alternatively a plurality of fluid inlet elements and/or fluid inlet elements different from a cone may be provided. Fluid inlet elements may also be positioned in another region of the rotational unit.

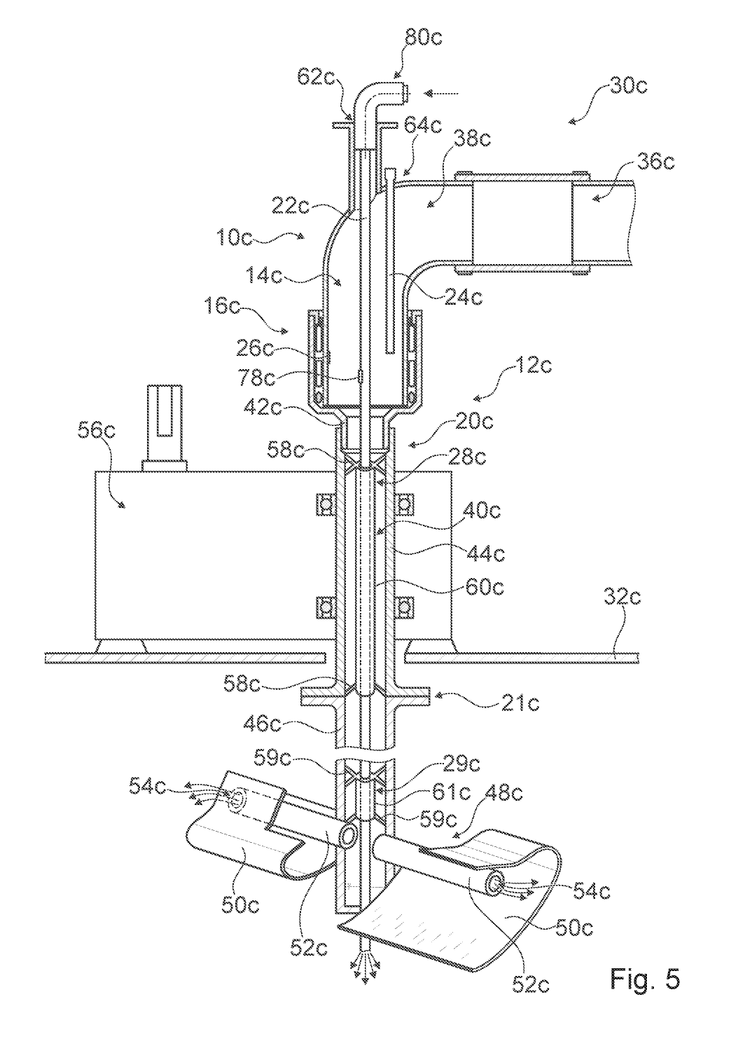

In FIG. 5, another embodiment of the invention is shown. The example of FIG. 5 is provided with suffix letter c. The example of FIG. 5 differs from the previous examples at least substantially by the form of a rotational unit 12c of an agitator device.

The rotational unit 12c is a multiple shaft. The rotational unit 12c comprises two concentric and mutually sealed hollow shafts. A first hollow shaft corresponds at least substantially to the rotational unit 12a of the first example. A second hollow shaft corresponds at least to a part of a lance element 22c. The lance element 22c is movable and provided in particular for rotating a rotational axis in at least one operating condition.

The agitator device is provided to this end with at least an additional rotational passage 80c. The additional rotational passage 80c is in a housing opening 62c. The additional rotational passage 80c comprises at least one part of another static unit (not shown), in particular a supply unit, and at least one part of the lance element 22c.

Here, the lance element 22c is a dosing lance. The lance element 22c is at least mostly positioned in a fluid channel 14c. The lance element 22c is permanently disposed in the fluid channel 14c. Alternatively the lance element is only temporarily positioned in the fluid channel and/or an additional rotational passage is omitted. The lance element 22c is provided for dosing in at least one operating condition, a dosing fluid and to supply the same in controlled conditions to an agitation medium 34c. The supply of the dosing fluid occurs here on an end of the rotational unit 12c, which is opposed to the static unit 10c. Alternatively the supply of dosing fluid may occur in another region of a rotational unit.

In order to reinforce and/or stiffen the rotational unit 12c, the agitator device also comprises another ribbed unit 29c. The additional ribbed unit 29c is at least substantially identical to a ribbed unit 28c. The additional ribbed unit 29c is positioned in the fluid channel 14c. Here, the additional ribbed unit 29c is positioned in a region of a third part 46c of the rotational unit 12c. The additional ribbed unit 29c is integrally formed. The additional ribbed unit 29c is also integral with the rotational unit 12c, in particular with the third part 46c of the rotational unit 12c. The additional ribbed unit 29c is provided for mechanically stabilizing the rotational unit 12c, in particular the third part 46c of the rotational unit 12c. To this end, the additional ribbed unit 29c has a plurality of other ribs 59c, which, in a mounted state are supported against an inner wall of the fluid channel 14c. The additional ribbed unit 29c also comprises at least anther lance guiding element 61c.

The additional lance guiding element 61c has a hollow tubular form. The additional lance guiding element 61c is centrally positioned in the fluid channel 14c. The additional lance guiding element 61c extends at least substantially over the entire main extension length of the third part 46c of the rotational unit 12c. The additional lance guiding element 61c is provided for guiding the lance element 22c at least partially. Alternatively, an additional ribbed unit may also be omitted.

Due to this configuration, a process result in connection with a parallel operating gassing operation may be improved.

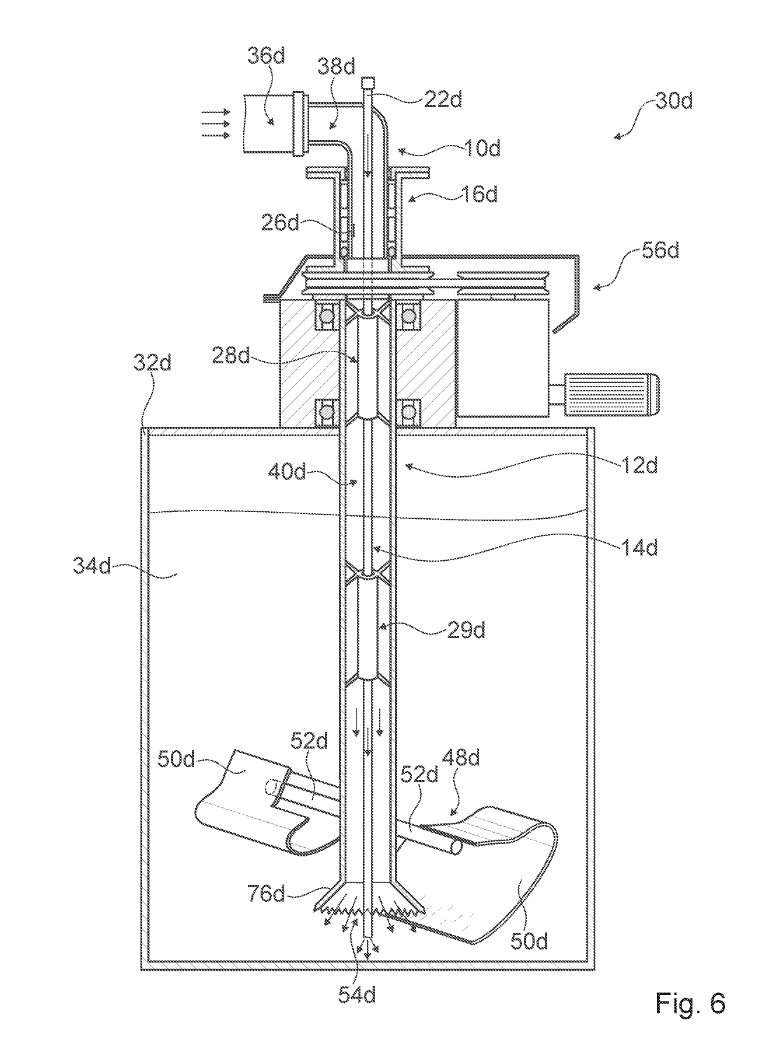

FIG. 6 shows another example of the invention. In example 6 suffix d is used. The example of FIG. 6 differs from previous examples at least substantially due to an elaboration of a rotational unit 12d and of the used lance element 22d of an agitator device.

In this case, the rotational unit 12d corresponds at least substantially to the rotational unit 12b of the second example. Moreover, the agitator device comprises a lance element 22d, a ribbed unit 28d and an additional ribbed unit 29d, which respectively correspond, at least substantially, to a form of the third example.

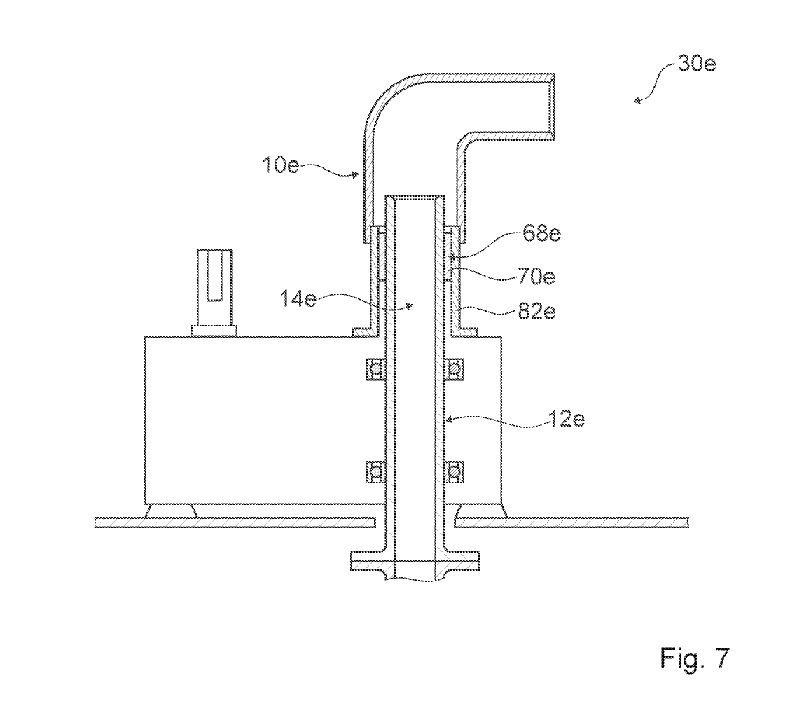

In FIG. 7 another example of the invention is shown. In the example of FIG. 7 the suffix e is used.

In this case, an agitator device comprises, in particular additionally, an encasing unit 82e. The encasing unit 82e surrounds a rotational unit 12e at least substantially entirely. The encasing unit 82e closes the rotational unit 12e in the direction of an external area. The encasing unit 82e is a protection unit. The encasing unit 82e is provided for sealing a transition region between a static unit 10e and the rotational unit 12e and in particular for protecting against dirt. The encasing unit 82e has, to this end, a sealed connection with a drive unit 56e. Moreover, the encasing unit 82e is provided for preventing a contact of the rotational unit 12e and/or other rotating parts of the agitator device from the outside.

In the present case, the encasing unit 82e is part of the static unit 10e. The encasing unit 82e is integrally formed with the static unit 10e.

The agitator device also comprises a sealing unit 68e, which in the present case comprises exactly one sealing element 70e.

Alternatively it may be envisaged to connect an encasing unit with a dynamic fit and/or a form fit to a static unit. Moreover it may be envisaged to separately form an encasing unit from a static unit. In particular, also examples of FIGS. 1 to 6 may have an encasing unit, whereby the protection and/or operating safety may be improved.

1. An agitator device having a static unit and a rotational unit which is in the form of an agitator shaft and, in an assembled state, forms together with the static unit at least one common fluid channel for a fluid, characterized in that a flow cross-section of the fluid channel, viewed along a main course of flow, is at least substantially constant at least in a coupling region between the static unit and the rotational unit.

2. The agitator device of claim 1, wherein the flow cross section in the coupling region has a surface area of at least 15% of a maximum flow cross section of the fluid channel.

3. The agitator device of claim 1, wherein the fluid channel has in the coupling region, viewed along the main flow course, a radius of curvature, which is at least equal to the inner diameter of the static unit.

4. The agitator device of claim 1, wherein the rotational unit at least partially surrounds the static unit in the coupling region.

5. The agitator device of claim 1, further comprises a rotational passage, which has at least a part of the rotational unit, at least a part of the static unit and a bearing unit.

6. The agitator device of claim 1, wherein the static unit and/or the rotational unit have at least one separation unit, which are provided for allow a separation of the static unit and/or rotational unit.

7. The agitator device of claim 6, wherein the separation unit is a quick plugin coupling.

8. The agitator device of claim 1, further comprises at least one encasing unit, which surrounds at least for the most part the rotational unit at least in an operational condition.

9. The agitator device of claim 1, further comprises at least one lance element, which in at least one operational condition is at least partially positioned within the fluid channel.

10. The agitator device of claim 1, further comprises at least one pressure measurement unit, which is positioned, at least partially, within the fluid channel.

11. The agitator device of claim 1, further comprises at least one flowmeter unit, which is positioned, at least partially, within the fluid channel.

12. The agitator device of claim 1, further comprises at least one filling level measurement unit, which is positioned, at least partially, within the fluid channel.

13. The agitator device of any of claim 9, wherein the lance element, the pressure measurement unit, the flowmeter unit and/or the filling level measurement unit is positioned, at least partially, in the coupling region.

14. The agitator device of claim 1, further comprises at least one ribbed unit positioned, at least partially, in the fluid channel and is provided for mechanically stabilizing at least in portions the static unit and/or the rotational unit and/or for at least partially guiding the fluid.

15. An agitator with an agitator device of claim 1.

16. A system with at least one container and with at least one agitator of claim 15, which is positioned within the container.
